(19) United States
(12) Patent Application Publication
(10) Pub. No.: US 2007/0215006 A1
(43) Pub. Date: Sep. 20, 2007

(54) Photocatalyst, method for manufacturing the same, and molded articles

(75) Inventors: Yasuo Naganuma, Kawasaki (JP); Masato Wakamura, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/511,412

(22) Filed: Aug. 29, 2006

(30) Foreign Application Priority Data
Mar. 20, 2006 (JP) 2006-077260

(51) Int. Cl. C09C 1/02

(52) U.S. Cl. 106/462; 502/208

(57) ABSTRACT

The present invention provides a photocatalyst which is excellent in absorbability to organic materials and the like and is inexpensive, a method for manufacturing the photocatalyst at low cost with simple procedures, and molded articles using the photocatalyst. The photocatalyst of the present invention contains at least a porous body containing a calcium hydroxy apatite having photocatalytic activity. The method for manufacturing a photocatalyst of the present invention is a method for manufacturing the photocatalyst of the present invention, and includes doping a metal atom necessary for obtaining photocatalytic activity in an apatite contained in a bone. The molded articles are formed by using the photocatalyst of the present invention.

### CROSS-REFERENCE TO RELATED APPLICATIONS

This application is based upon and claims the benefits of the priority from the prior Japanese Patent Application No. 2006-077260, filed on Mar. 20, 2006, the entire contents of which are incorporated herein by reference.

### BACKGROUND OF THE INVENTION

1. Field of the Invention

The present invention relates to a photocatalyst which is excellent in absorbability to organic materials and is inexpensive, a method for manufacturing a photocatalyst at low cost with simple procedures, and molded articles using the photocatalyst.

2. Description of the Related Art

In recent years, photocatalytic activity held by, for example, titanium dioxide (TiO₂) exhibiting oxidative decomposition effect, antibacterial effect, antifouling effect, etc. has been a focus of attention, and the titanium dioxide has been widely used for filters such as for air purification systems, and air conditioners. However, titanium dioxide itself is poor in absorbability to materials, and thus in order to cause titanium dioxide to develop oxidative decomposition effect, antibacterial effect, and antifouling effect based on photocatalytic activity of the titanium dioxide, it is needed to improve its absorbability to decomposition targets by the titanium dioxide.

Then, titanium dioxides are used in combination with absorbents typified by, for example, activated carbon. However, all decomposition targets such as organic materials absorbed on activated carbon cannot be decomposed by titanium dioxide. The objects that can be decomposed by titanium dioxide are limited only to decomposition targets absorbed to portions where activated carbon particles are situated close to titanium dioxide particles. Thus, the decomposition efficiency to decomposition targets is not necessarily high.

Techniques utilizing properties of apatite have been studied and developed because apatite such as calcium hydroxy apatite Ca₁₀(PO₄)₆(OH)₂ easily ion-exchanges with various cations and anions, and has high biocompatibility, absorption property, and specific absorbability to organic materials such as protein. For example, a calcium titanium hydroxy apatite Ca₉Ti(PO₄)₆(OH)₂, so-called photocatalytic titanium hydroxy apatite (TiHAP), in which a part of calcium ions in the apatite is exchanged with titanium ions, is proposed in Japanese Patent Application Laid-Open (JP-A) No. 2001-302220. The photocatalytic titanium hydroxy apatite has approximately one half of photocatalytic effect of titanium dioxide, however, the absorption efficiency and decomposition efficiency of the photocatalyst titanium hydroxy apatite are more excellent than those of titanium dioxide. However, the photocatalyst titanium hydroxy apatite is produced by means of chemosynthesis, and the price thereof is about triple the price of titanium dioxide, and thus there is a problem that it results in a very high-cost when the photocatalyst titanium hydroxy apatite is used for various products.

The present invention aims to solve the conventional problems and achieve the following objects. Namely, the objects of the present invention are to provide a photocatalyst which is excellent in absorbability to organic materials and is inexpensive, a method for manufacturing a photocatalyst at low cost with simple procedures, and molded articles using the photocatalyst.

### SUMMARY OF THE INVENTION

The means for solving aforesaid problems are described in attached claims. Specifically, the photocatalyst of the present invention contains at least a porous body which contains a calcium hydroxy apatite having photocatalytic activity.

In the photocatalyst, the calcium hydroxy apatite having photocatalytic activity is excellent in absorbability to decomposition targets, and in particular, since the apatite is contained in the porous body, the absorbability to the decomposition targets is more improved, and the decomposition targets are more efficiently absorbed to the photocatalyst through air spaces residing inside the porous body. In the calcium hydroxy apatite having photocatalytic activity, the apatite itself has photocatalytic activity, and thus when the calcium hydroxy apatite having photocatalytic activity is irradiated with a given light, the apatite having photocatalytic activity exhibits photocatalytic activity, the photocatalytic activity takes electrons out of the decomposition target absorbed on the surface of the apatite, and then the decomposition target is oxidized and decomposed.

The photocatalyst is taken from bones, etc., in which the porous body contains calcium hydroxy apatite as a main component, and is taken, for example, from livestock, and when a bone or the like to be wasted under ordinary circumstances are utilized for the photocatalyst, the photocatalyst excels in not only absorbability but also in cost performance.

The method for manufacturing a photocatalyst of the present invention is a method for manufacturing the photocatalyst of the present invention, and includes at least doping a metal atom necessary for obtaining photocatalytic activity in apatite contained in a bone (hereinafter, may be referred to as “apatite-containing bone”).

In the method for manufacturing a photocatalyst, the metal atom necessary for obtaining photocatalytic activity is doped in apatite-containing bone in the doping. As the result, a photocatalyst can be efficiently manufactured. In the method for manufacturing a photocatalyst, the apatite-containing bone is used as a raw material of the photocatalyst of the present invention, and thus when a bone which is obtainable from livestock and is to be wasted under ordinary circumstances is utilized, it is possible to manufacture the photocatalyst at lower cost and with more simple procedures than in a method for manufacturing a photocatalyst by means of chemosynthesis.

The molded articles of the present invention are formed by using the photocatalyst of the present invention. The molded articles are applicable to wide areas such as office automation (OA) equipment, electronic devices, electric appliances, portable information terminals, filters, wallpaper, food trays, medical instruments, artificial teeth, interior or exterior decorating materials, vehicles, assist straps, drivers' wheels, saddles, shoes, and bags.

### BRIEF DESCRIPTION OF THE DRAWINGS

FIG. 1 is a view schematically showing an example of a manufacturing process of the method for manufacturing an photocatalyst of the present invention.

FIG. 2 is a graph showing evaluation results on photocatalytic activity of the photocatalyst of the present invention and a commercially available photocatalyst.

FIG. 3 is a graph showing evaluation results on absorbability to the photocatalyst of the present invention and a commercially available photocatalyst.

### DESCRIPTION OF THE PREFERRED EMBODIMENTS

### (Photocatalyst)

The photocatalyst of the present invention contains at least a porous body which contains a calcium hydroxy apatite having photocatalytic activity and further contains other components suitably selected in accordance with the necessity.

### —Porous Body—

The porous body is not particularly limited as long as the porous body contains a calcium hydroxy apatite (hereinafter, referred to as “apatite” simply), and may be suitably selected in accordance with the intended use. Preferred examples thereof include bones and teeth each of which contains a calcium hydroxy apatite as a main component.

The bones and teeth are not particularly limited, may be suitably selected in accordance with the intended use, and preferred examples thereof include bones or teeth which are obtainable from livestock, for example, from bovines, swine, and chickens. Since they are to be wasted after used for edible meat in livestock industry, these bones and teeth can be easily obtained at low cost, and it is advantageous in reduction of manufacturing cost.

### —Calcium Hydroxy Apatite having Photocatalytic Activity—

The calcium hydroxy apatite having the photocatalytic activity (photocatalytic property) is not particularly limited and may be suitably selected in accordance with the intended use. Preferred examples thereof include those in which the calcium hydroxy apatite has a metal atom necessary for obtaining photocatalytic activity (hereinafter, sometimes referred to as a metal atom capable of exhibiting photocatalytic activity). When the calcium hydroxy apatite has a metal atom necessary for obtaining photocatalytic activity, and the apatite is irradiated with light, the apatite is activated by action of the metal atom necessary for obtaining photocatalytic activity, it can take electrons out of the decomposition target which is absorbed on the surface of the apatite to oxidize the decomposition target to thereby decompose the decomposition target.

The calcium hydroxy apatite (CaHAP) contains calcium (Ca) atoms which excel in absorbability, and phosphorous (P) atoms which excel in biocompatibility, and it is represented by Ca₁₀(PO₄)₆(OH)₂.

Since the calcium hydroxy apatite (CaHAP) easily ion-exchanges with both cation and anion, the calcium hydroxy apatite is preferable in that it is excellent in absorption property to various decomposition targets, is particularly excellent in absorbability to organic materials such as protein as well as excellent in absorption property to microorganism such as viruses, fungi, and bacteria, and enables preventing or constricting proliferation thereof.

The decomposition targets are not particularly limited and may be suitably selected in accordance with the intended use, and examples thereof include proteins, amino acids, lipids, and carbohydrates. The decomposition target may contain one of them singularly, or may contain two or more. Specific examples thereof include smudge derived from human skin, garbage, dust, polluted sludge, unnecessary components, waste water components, harmful components in soil or air, microorganism, and viruses. Examples of the harmful components include acetaldehyde gases. The microorganism is not particularly limited, it may be procaryote or eukaryote, and includes protozoan. Examples of the procaryote include bacteria such as Escherichia coli, and Staphylococcus aureus bacteria. Examples of the eukaryote include mould fungi such as yeast fungi, mold, and Actinomycetes. Examples of the viruses include DNA viruses, and RNA viruses. Specifically, there are influenza viruses. These decomposition targets may exist in any embodiment of solid, liquid, and vapor. Examples of the decomposition targets in liquid form include waste fluid, nutrient fluid, and circulation fluid. Examples of the decomposition targets in vapor form include air, exhaust gas, and circulation gas.

The content of the calcium hydroxy apatite in the photocatalyst is not particularly limited and may be suitably adjusted in accordance with the intended use. For example, it is preferably 85 mole % to 97 mole %, and more preferably 85 mole % to 90 mole %.

When the content of the calcium hydroxy apatite is less than 85 mole %, the photocatalytic activity of the photocatalyst may not be sufficiently exhibited, and even when it is more than 97 mole %, appropriate effect may not be obtained, and absorption property and photocatalytic activity of the photocatalyst relative to the decomposition targets may be degraded.

The content of apatite of in the photocatalyst can be, for example, measured by performing quantitative analysis by ICP-AES.

The metal atom necessary for obtaining photocatalytic activity is not particularly limited as long as it can function as a center of photocatalyst, and may be suitably selected from among those known in the art as the metal atom having photocatalytic activity. Preferred examples thereof include at least one selected from the group consisting of titanium (Ti), Zinc (Zn), manganese (Mn), tin (Sn), indium (In), and iron (Fe). Of these, titanium (Ti) is particularly preferable in that Ti is excellent in the photocatalytic activity (photocatalytic ability).

The content of the metal atom necessary for obtaining photocatalytic activity is not particularly limited and may be adjusted in accordance with the intended use. For example, it is preferably 5 mole % to 15 mole % and more preferably 8 mole % to 12 mole % relative to the total metal atom in the photocatalyst.

When the content of the metal atom necessary for obtaining photocatalytic activity is less than 5 mole %, photocatalytic activity of the photocatalyst may be insufficiently exhibited, and even when it is more than 15 mole %, appropriate effect may not be obtained, and absorption property or photocatalytic activity of the photocatalyst relative to decomposition targets may be degraded.

The content of the metal atom necessary for obtaining photocatalytic activity can be, for example, measured by performing quantitative analysis by ICP-AES.

The metal atom necessary for obtaining photocatalytic activity is incorporated (for example, by substitution) into the crystal structure of the calcium hydroxy apatite as part of metal atoms constituting the crystal structure of the apatite to thereby form a “photocatalytic substructure” which is capable of exhibiting photocatalytic function in the crystalline structure of the apatite.

Since the calcium hydroxy apatite having such a photocatalytic substructure exhibits photocatalytic activity, and the apatite structure portions are excellent in absorption property and are more excellent in absorption property relative to the harmful components (decomposition targets) than the known metal oxides having photocatalytic activity, the calcium hydroxy apatite excels in decomposition effect, antibacterial effect, antifouling effect and inhibition and/or reduction of proliferation of fungi, bacteria, and the like.

The form of the photocatalyst is not particularly limited, and the shape, size, etc. thereof can be suitably selected.

Examples of the shape of the photocatalyst include powdery form, particulate form (granular form), tablet form, rod form, plate form, block form, sheet form, and film form. Of these, powdery form is preferably in terms of ease of handling.

Observations of the photocatalyst, for example, identification and form thereof can be observed by means of TEM (transmission electron microscope), XRD (X-ray diffractometer), XPS (X-ray photoelectron spectroscopy), and FT-IR (Fourier transform infrared spectroscopy), or the like.

The wavelength of light necessary for exhibiting photocatalytic activity of the photocatalyst is not particularly limited and may be suitably selected in accordance with the intended use, however, wavelength capable of exhibiting absorption property relative to light having a wide band such as ultraviolet rays or visible lights and exhibiting photocatalytic activity.

Property (photocatalytic activity) of the photocatalyst can be evaluated by measuring the density of the decomposition target, decomposition product, or the like. When the decomposition target is, for example, aldehyde gas, the photocatalyst to be evaluated is irradiated with ultraviolet ray under specific conditions, and the density (ppm) of the aldehyde gas, and the density (ppm) of carbon dioxide of the decomposition product are analyzed and monitored to thereby evaluate photocatalytic activity of the photocatalyst.

When the decomposition target or the decomposition product is a gas, for example, acetaldehyde gas, the density of the acetaldehyde gas can be measured by gas chromatography.

### —Aspects of Use of Photocatalyst—

The photocatalyst of the present invention may be used by itself or may be used in combination with other materials, or may be dispersed in a solution etc. to form it in a slurry state or the like for use. When the photocatalyst is used in a slurry state, the solution is preferably water or an alcohol solvent, and such a slurry can be preferably used as a photocatalyst-containing slurry.

The photocatalyst may be directly used by itself, or may be pulverized and mixed with another composition for use as a mixed composition, or may be make it adhere on a surface of a base, applied over the base surface to be evaporated thereon as a film (a coated layer) for use. When the photocatalyst is made to adhere on a surface of a base, and applied over the base surface to be evaporated thereon, a coating solution can be preferably used.

The method of pulverizing the photocatalyst is not particularly limited and may be suitably selected in accordance with the intended use. Preferred examples thereof include a method of pulverizing the photocatalyst by using a ball mill.

The another composition is not particularly limited, may be suitably selected in accordance with the intended use, and examples thereof include printing inks.

The mixing method is not particularly limited, may be suitably selected in accordance with the intended use, and examples thereof include a method of mixing the photocatalyst with another composition by using, for example, a kneader, a stirrer, or the like.

The base is not particularly limited as to the material, form, structure, thickness, etc. thereof, and may be suitably selected from among those known in the art. Examples of materials of the base include paper, synthetic paper, woven cloth, unwoven cloth, leather, wood materials, glass, metal, ceramics, and synthetic resins. Examples of the form of the base include foil, film, sheet, and plate.

The method of making the photocatalyst adhere on a surface of the base is not particularly limited, may be suitably selected in accordance with the intended use, and examples thereof include spraying method.

The method of applying the photocatalyst over the base surface is not particularly limited, may be suitably selected in accordance with the intended use, and examples thereof include spray-coating method, curtain coating method, spin-coating method, gravure coating method, ink-jet method, and dip-coating method.

Examples of the method of making the photocatalyst evaporated on the base surface include CVD method, sputtering method, and vacuum evaporation method.

The coating solution is not particularly limited as long as the coating solution contains the photocatalyst of the present invention, and may be suitably selected in accordance with the intended use. Preferred examples thereof include a coating solution that can be obtained by a method in which an alcohol solution that has been obtained by adding the photocatalyst of the present invention to isopropyl alcohol (IPA) is added to and mixed with a curable inorganic coating agent at room temperature (a mixture which is obtained by mixing a fluid material S00 with a fluid material UTE01 (both available from available from NIHON YAMAMURA GLASS CO., LTD.) at a mixture ratio of 10:1) as an inorganic coating solution material.

### —Application, etc.—

Since the photocatalyst of the present invention excels in absorption property relative to the decomposition targets, it is excellent in photocatalytic activity relative to various decomposition targets and decomposition capability relative to decomposition targets, and it is possible to efficiently decompose the decomposition targets. For the reason, the photocatalyst can be preferably used in various areas. For example, it can be preferably used for OA equipment (housing of personal computer, mouse, and keyboard); electronic devices (telephone set, copier, facsimile, various printers, digital camera, video player, CD device, DVD device, air conditioner, and remote control device); electric appliances (dishwasher, dish drier, cloth drier, washing machine, air purification system, humidifier, fan motors, ventilation fan, cleaner, and garbage processor); portable information terminals (PDA (Personal Digital Assistant), and cellular phone); filters (gas filters used for air purification system; air conditioner, etc., liquid filters used for disposal of solution used in hydroponic culture; and solid filters used for soil improvement, and filters for camera); wall paper; food trays (repetitively usable trays, disposable trays); medical instrument/sanitary articles (mask part of oxygen inhalation, bandage, mask, and antibacterial glove); fiber products (clothing, etc.); artificial teeth; interior or exterior decorating materials (those made of resin, paper, cloth, ceramics, metal, etc. or interior or exterior decorating materials used for bath room, pool, and architectural materials, those used in medical facility which are configured such that light of fluorescent lamp is applied when human is necessary to use and ultraviolet ray is applied when human is unnecessary to use; those used for bio-laboratory, clean bench); vehicles (interior materials, mirror for checking safety of backside of the vehicle); assist straps used in train, bus, etc.; drivers' wheels (bicycle, tricycle, two-wheeled motor vehicle, passenger vehicles, etc.); saddles (bicycle, tricycle, and two-wheeled motor vehicle, etc.); shoes (shoes made of cloth, resin, artificial leather, synthetic resin or the like); bags (bags made of cloth, resin, artificial leather, synthetic resin or the like); sewage/drainage water disposing materials; sheets (soil treatment sheet); biotip electrodes; mirrors (bath room mirror, lavatory mirror, dental mirror, road mirror, etc.); lenses (eyeglass-lens, optic lens, illumination lens, semiconductor lens, lens for copier, and camera lens for checking the backside in a vehicle), prisms, glass (window panes of buildings and lookout tower; window panes of vehicles such as for automobile, railroad vehicle, airplane, marine vessel, submarine, snow wagon, gondola of ropeway, gondola in amusement park, and window panes of vehicles like spaceship; windshields of vehicles such as for automobile, auto-bicycle, railroad vehicle, airplane, marine vessel, snow wagon, snowmobile, gondola in amusement part, and vehicle like spaceship; glass such as for frozen food display case, and display case of heat-insulating food such as Chinese steamed buns); goggles (goggle for protection, goggle for sports, etc.); shields (mask shields for protection, helmet shield, etc.); covers (cover for measurement hardware, cover for camera lens for checking the backside for vehicle, etc.), lenses (focusing lenses such as for laser-dentistry equipment), and covers (cover for photodetector sensor such as inter-vehicular distance sensor, cover for infrared light sensor, film, sheet, seal, and patch or emblem). Of these, the photocatalyst is particularly preferably used for the filter.

The photocatalyst of the present invention can be manufactured in accordance with a suitably selected method, however, the photocatalyst can be particularly preferably manufactured by the method for manufacturing a photocatalyst of the present invention, which will be described in detail.

### (Method for Manufacturing a Photocatalyst)

The method for manufacturing a photocatalyst of the present invention includes at least doping, and preferably heat treatment, and further includes other steps suitably selected in accordance with the necessity.

### <Doping>

In the doping, a metal atom necessary for obtaining photocatalytic activity is doped in an apatite contained in a bone.

It should be noted that details of the bone, the apatite, and the metal atom necessary for obtaining photocatalytic activity are the same as described above, in the explanations of the photocatalyst of the present invention. Preferred examples of the bone include bones of livestock, preferred examples of the apatite include calcium hydroxy apatite (CaHAP), and preferred examples of the metal atom necessary for obtaining photocatalytic activity include titanium (Ti).

The aspect of doping is not particularly limited and may be suitably selected in accordance with the intended use. Examples thereof include substitution, chemical bonding, and absorption. Of these, substitution is preferable because reaction is easily controllable, and metal atom necessary for obtaining photocatalytic activity can be held stably in the photocatalyst without detachment after doping.

The aspect of substitution is not particularly limited and may be suitably selected in accordance with the intended use. For example, there is a preferable aspect in which at least a part of calcium atom (Ca) in the calcium hydroxy apatite (CaHAP) as the apatite is substituted with the metal atom necessary for obtaining photocatalytic activity. When the aspect is employed, it is advantageous in that the metal atom necessary for obtaining photocatalytic activity can be held stably in the apatite without detachment.

The types of substitution with the metal atom necessary for obtaining photocatalytic activity are not particularly limited and may be suitably selected in accordance with the intended use, and preferred examples include ion exchange. When ion exchange is employed as substitution, it is advantageous in terms of excellence in substitution efficiency.

The specific method for doping, that is, the specific method for doping the metal atom necessary for obtaining photocatalytic activity in the apatite is not particularly limited and may be suitably selected in accordance with the intended use. It is preferable to employ a dipping method in which the apatite-containing bone is dipped in a water solution containing ions of the metal atom necessary for obtaining photocatalytic activity.

The water solution may be left at rest; however, it is preferable to stir the solution for more efficient substitution to take place. The solution may be stirred by means of known equipment and units, and a magnetic stirrer or a stirring apparatus may be used.

The stirring time is not particularly limited, may be suitably selected in accordance with the intended use. For example, when the metal atom necessary for obtaining photocatalytic activity is titanium (Ti), it is preferably 3 minutes to 5 minutes. Since titanium (Ti) ions are ion-exchanged at a high-speed, appropriate effect may not be obtained even when the doping time is more than 5 minutes.

The density of the apatite in the water solution during doping is not particularly limited and may be suitably adjusted in accordance with the intended use. For example, it is preferably 0.3% by mass to 1.0% by mass and more preferably 0.4% by mass to 0.6% by mass.

When the density of the apatite is less than 0.3% by mass, photocatalytic activity may be degraded, and even when it is more than 1.0% by mass, appropriate enhancing effect of photocatalytic activity may not be obtained and, adversely, photocatalytic activity may be degraded.

The density of the metal atom necessary for obtaining photocatalytic activity in the water solution during doping is not particularly limited and may be suitably adjusted in accordance with the intended use. For example, it is preferably 1×10⁻²M or less, and more preferably 1×10⁻⁴M to 1×10⁻²M.

When the density of the metal atom necessary for obtaining photocatalytic activity is more than 1×10⁻²M, an apatite with a low-acid resistance is dissolved, and then the yield of the photocatalyst may be reduced. When the density of the metal atom necessary for obtaining photocatalytic activity is excessively low, the doped amount of the metal atom necessary for obtaining photocatalytic activity in the apatite may be reduced.

The reaction system used for doping is not particularly limited and may be suitably selected in accordance with the intended use. The reaction may take place in liquid and air, for example, and it is preferably performed in liquid.

In this case, the liquid is not particularly limited and may be suitably selected in accordance with the intended use, and it is preferably water or a liquid mainly consisting of water.

The container to make the liquid contained therein is not particularly limited and may be suitably selected from among known containers. The preferred examples thereof include mixers and stirrers in large scale, and beakers in small scale.

The doping conditions are not particularly limited and the temperature, time and pressure, etc. may be suitably selected in accordance with the intended use.

The temperature is not particularly limited, and it differs depending on the type and mass ratio of the material and cannot be defined exactly. Typically, it is approximately 0° C. to 100° C. and preferably at room temperature (20° C. to 30° C.), for example.

The doping time is not particularly limited and it differs depending on the type and mass ratio of the material and cannot be defined exactly. Typically, it is approximately 10 seconds to 30 minutes and preferably 1 minute to 10 minutes. For example, when the metal atom necessary for obtaining photocatalytic activity is titanium (Ti), it is preferably approximately 3 minutes to 5 minutes. Since titanium (Ti) ions are ion-exchanged at a high-speed, even when the doping time is more than 5 minutes, appropriate effect may not be obtained.

The pressure is not particularly limited and it differs depending on the type and mass ratio of the material and cannot be defined exactly. It is preferably atmospheric pressure.

### <Heat Treatment>

In the heat treatment, apatite-containing bone is heated at 300° C. or more after the doping.

In the heat treatment, after doping the metal atom necessary for obtaining photocatalytic activity in the apatite-containing bone (after the doping), the apatite containing bone that the doping has been completed is heated at 300° C. or more. The heating treatment temperature is preferably 500° C. to 800° C., and more preferably 600° C. to 650° C.

When the heating treatment temperature is less than 300° C., the bone is insufficiently made into a porous state, the porous state being induced by burning of collagen contained in the bone, and the absorption property of the photocatalyst relative to the decomposition target may be degraded, and the photocatalyst activity of the photocatalyst may not be maximized.

The conditions for the heat treatment, for example, the heating time, atmosphere, pressure, equipment, etc. are not particularly limited and may be suitably selected in accordance with the intended use.

The heating time differs depending on the amount of apatite that the doping has been completed and cannot be exactly defined, however, it is preferably 1 hour or more, and more preferably 1 hour to 2 hours. Examples of the atmosphere employed in the heating treatment include inert gas atmosphere such as nitrogen gas, and argon gas; and atmospheric air. Of these, atmospheric air is preferable. Examples of the pressure include atmospheric pressure. In addition, known sintering apparatuses may be used as the equipment.

Through the aforesaid procedures, after the doping, the apatite-containing bone is heat treated at 300° C. or more, collagen contained in the bone is burned to thereby form the bone in a porous state. As the result, the photocatalytic ability, including absorption property, photocatalytic activity, etc., of in the photocatalyst can be enhanced.

### <Other Steps>

The other steps are not particularly limited, may be suitably selected in accordance with the intended use, and examples thereof include filtration, washing, and drying.

In the filtration, after doping the metal atom necessary for obtaining photocatalytic activity in the apatite containing bone in the water solution by a dipping method, the doped bone residing in the water solution is filtrated.

The filtration is followed by the washing. In the washing, the filtrated bone (the apatite containing bone in which the metal atom necessary for obtaining the photocatalytic activity has been doped) is washed.

The washing is followed by the drying. In the drying, the washed bone (the bone containing apatite in which the metal atom necessary for obtaining the photocatalytic activity has been doped) is dried. The conditions of drying, such as temperature, time, etc. are not particularly limited as long as the bone can be sufficiently dried. For example, the drying temperature is approximately 100° C., and the drying time is approximately 1 hour.

Here, one example of the method for manufacturing a photocatalyst will be described. When the doping is performed by substitution, specifically when the substitution is performed by ion exchange by a dipping method, a titanium sulfate water solution containing titanium (Ti) as the metal atom necessary for obtaining photocatalytic activity is prepared. Bone powder (the bone) containing the calcium hydroxy apatite (CaHAP) is weighed, and added to a beaker. To the beaker, the titanium sulfate water solution is added, the mixed solution is stirred with a magnetic stirrer for 5 minutes (this procedure is the doping), and then sucked and filtrated through filter paper using an aspirator (this procedure is the filtration), the filtrated mixture is washed with pure water (this procedure is the washing) and then dried in an oven at 100° C. for 1 hour (this procedure is the drying) to thereby obtain bone powder containing the calcium hydroxy apatite (CaHAP) in which the titanium has been doped. Thereafter, the bone powder is heated in an electric furnace at 650° C. for 1 hour in atmospheric air, collagen contained in the bone powder is burned to thereby form the bone powder in a porous state (this procedure is the heat treatment). Through these procedures, it is possible to manufacture photocatalyst having at least bone powder in which titanium (Ti) as the metal atom necessary for photocatalytic activity is doped (the porous body containing apatite having photocatalytic activity).

### (Molded Article)

The molded article is not particularly limited as long as the molded article is formed by using the photocatalyst of the present invention, and the shape, structure, size, etc. are suitably selected in accordance with the intended use.

The method for forming a molded article is not particularly limited and may be suitably selected from among known methods in accordance with the intended use. Examples thereof include film molding, extrusion molding, injection molding, blow molding, compression molding, transfer molding, calendar molding, thermoforming, flow molding, laminate molding, or compression molding using a mold. Of these, when the molded article is obtained as an electronic component such as a housing of personal computer, a key board, a mouse, and a portable information terminal, the molding method is preferably one selected from film molding, extrusion molding, and injection molding.

The molded article has the photocatalyst at least on the surface thereof and/or the inside thereof.

Specific examples of the molded article include those similar to the aforesaid various products exemplarily shown as application of the photocatalyst of the present invention.

### EXAMPLES

Hereinafter, the present invention will be described in detail referring to specific examples, however, the present invention is not limited to the disclosed examples.

### Example 1

### —Manufacturing of Photocatalyst—

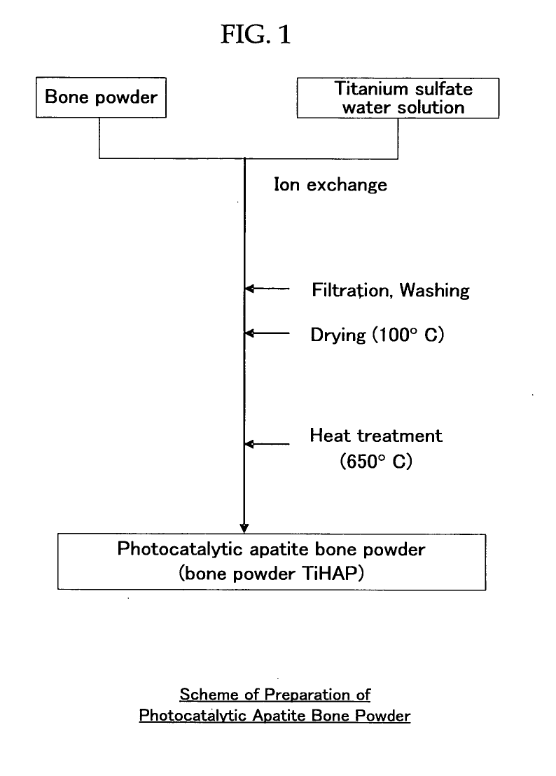

As shown in FIG. 1, first, bovine bone powder containing calcium hydroxy apatite (CaHAP) as a main component was weighed 3 g. Next, the bone powder was added to 300 ml of a titanium water solution of 1×10⁻²M containing titanium (Ti) used as the metal atom necessary for obtaining photocatalytic activity to prepare a mixed solution. The mixed solution was stirred with a magnetic stirrer for 5 minutes to ion-exchange the mixed solution. These procedures are the doping. Thereafter, the mixture solution was sucked and filtrated. This procedure is the filtration. The obtained filtration product was washed with pure water. This procedure is the washing. Next, the filtration product was dried in an oven at 100° C. for 2 hours. This is the drying. Thereafter, the dried product was heated in an electric finance in atmospheric air at 650° C. for 1 hour. Collagen and the like in the bone were burned through the heat treatment, and the burning caused air spaces in the bone, and the bone powder was made in a porous state. These procedures are the heat treatment. Through the above-mentioned procedures, the bovine bone powder in which titanium being the metal atom necessary for obtaining photocatalytic activity, i.e. a porous body containing an apatite containing the metal atom (titanium) necessary for obtaining photocatalytic activity had been doped in the calcium hydroxy apatite, was obtained as a photocatalyst in a powder state of Example 1.

### <Evaluation of Photocatalytic Activity>

Individual powders of the photocatalyst obtained in Example 1 (hereinafter, may be referred to as “bone powder TiHAP”), and a commercially available photocatalyst manufactured by chemosynthesis (calcium•titanium hydroxy apatite (TiHAP; PHOTOHAP PCAP-100 available from TAIHEIYO CHEMICAL INDUSTRIAL CO., LTD.) were respectively weighed 1 g, added to a 500 mL closed vessel, and the content in the vessel was substituted with synthetic air (oxygen 30% by volume-nitrogen 70% by volume). Next, 12 mL of acetaldehyde gas was fed into the vessel using a syringe, and the vessel was left in a dark place until the time to reach the absorption equilibrium between acetaldehyde gas and the photocatalyst powder (around 2 hours). Thereafter, the photocatalyst powder was left in a dark place for 1 hour and then irradiated with ultraviolet ray. One hour later, two hours later, three hours later, and four hours later of the irradiation, the gas contained in the vessel was extracted using a syringe to measure the density of carbon dioxide gas generated by decomposition of acetaldehyde gas using a gas chromatography spectrometer (GC-390B, available from GL Science Inc.). Table 2 shows the measurement results. For the irradiation of ultraviolet ray, a black light (1 mW/cm²) was used.

### <Evaluation of Absorbability>

In the same manner as in the <Evaluation of Photocatalytic Activity>, individual powders of the bone powder TiHAP obtained in Example 1, and the commercially available TiHAP were respectively weighed 1 g, added to a closed vessel, and the content in the vessel was substituted with synthetic air. Then, 12 mL of acetaldehyde gas was fed into the vessel using a syringe, and the vessel was left in a dark place until the time to reach the absorption equilibrium between acetaldehyde gas and the photocatalyst powder (around 2 hours). Thereafter, the photocatalyst powder was left in a dark place for 1 hour and then irradiated with ultraviolet ray. One hour later, two hours later, three hours later, and four hours later of the irradiation, the gas contained in the vessel was extracted using a syringe to measure the density of carbon dioxide gas generated by decomposition of acetaldehyde gas using a gas chromatography spectrometer (GC-390B, available from GL Science Inc.). Table 3 shows the measurement results.

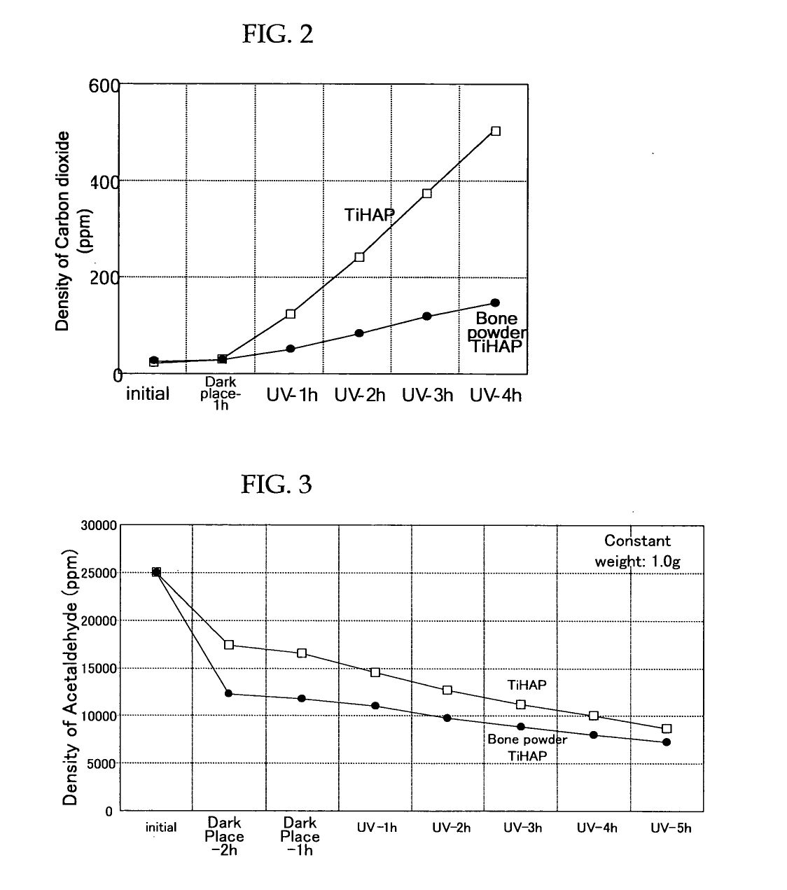

FIG. 2 shows that the photocatalytic activity of the bone powder TiHAP obtained in Example 1 was approximately one third of that of the TiHAP obtained by chemosynthesis, however, it was found that, as shown in FIG. 3, the bone powder TiHAP had a lower acetaldehyde density than that of the TiHAP obtained by chemosynthesis, the absorption amount of the bone powder TiHAP at the early stage was 1.7 times that of the TiHAP obtained by chemosynthesis, and the bone powder TiHAP had excellent absorbability.

The present invention can solve the conventional problems and provide a photocatalyst which is excellent in absorbability to organic materials and the like and is inexpensive, a method for manufacturing the photocatalyst at low cost with simple procedures, as well as molded articles using the photocatalyst.

Since the photocatalyst of the present invention is excellent in absorbability to organic materials and the like and is inexpensive, it can be preferably used in various areas. For example, the photocatalyst can be preferably used for filters (gas filters for: air purification system, air conditioner, etc., liquid filters for: disposal of solution used in hydroponic culture, etc., and solid filters for: soil improvement, and camera filters; wall paper, and the like).

The method for manufacturing a photocatalyst of the present invention enables manufacturing a photocatalyst at low cost with simple procedures, and the method can be preferably used in manufacturing the photocatalyst of the present invention.

The molded articles of the present invention can be preferably used for the same application as described in the photocatalyst of the present invention, because they contain the photocatalyst of the present invention.

What is claimed is:

1. A photocatalyst comprising:
a porous body which comprises a calcium hydroxy apatite having photocatalytic activity.

2. The photocatalyst according to claim 1, wherein the porous body is a bone.

3. The photocatalyst according to claim 1, wherein the calcium hydroxy apatite is a metal atom necessary for obtaining photocatalytic activity.

4. The photocatalyst according to claim 3, wherein the metal atom necessary for obtaining photocatalytic activity is at least one selected from titanium (Ti), zinc (Zn), manganese (Mn), tin (Sn), indium (In), and iron (Fe).

5. The photocatalyst according to claim 4, wherein the metal atom necessary for obtaining photocatalytic activity is titanium (Ti).

6. A method for manufacturing a photocatalyst comprising:
doping a metal atom necessary for obtaining photocatalytic activity in an apatite-containing bone,
wherein the photocatalyst comprises at least a porous body which comprises a calcium hydroxy apatite having photocatalytic activity.

7. The method for manufacturing a photocatalyst according to claim 6, wherein the metal atom necessary for obtaining photocatalytic activity is at least one selected from titanium (Ti), zinc (Zn), manganese (Mn), tin (Sn), indium (In), and iron (Fe).

8. The method for manufacturing a photocatalyst according to claim 7, wherein the metal atom necessary for obtaining photocatalytic activity is titanium (Ti).

9. The method for manufacturing a photocatalyst according to claim 6, wherein the doping is performed by making at least a part of metal atoms in the apatite substituted by the metal atom necessary for obtaining photocatalytic activity.

10. The method for manufacturing a photocatalyst according to claim 9, wherein the substitution by the metal atom necessary for obtaining photocatalytic activity is performed by ion exchange.

11. The method for manufacturing a photocatalyst according to claim 6, wherein the metal atom necessary for obtaining photocatalytic activity in the apatite-containing bone is doped by dipping the apatite-containing bone in a water solution which comprises the metal atom necessary for obtaining photocatalytic activity.

12. The method for manufacturing a photocatalyst according to claim 6, further comprising heating the apatite-containing bone at 300° C. or more after the doping.

13. A molded article formed by using a photocatalyst, wherein the photocatalyst comprises at least a porous body which comprises a calcium hydroxy apatite having photocatalytic activity.
